(19) United States
(12) Patent Application Publication
(10) Pub. No.: US 2008/0072720 A1
(43) Pub. Date: Mar. 27, 2008

(54) Method of peeling a foil from a supply block

(75) Inventors: Rolf Potzsch, Freudenberg (DE); Rudolf Schmitt, Pleckhausen (DE); Wolfgang Utsch, Herdorf (DE)

Correspondence Address: K.F. ROSS P.C., 5683 RIVERDALE AVENUE, SUITE 203 BOX 900, BRONX, NY, 10471-0900, US

(73) Assignee: ALBRECHT BAUMER GmbH & CO. KG

(21) Appl. No.: 11/810,354

(22) Filed: Jun. 5, 2007

(30) Foreign Application Priority Data
Jun. 9, 2006 (DE) 102006027271.4

(51) Int. Cl. B23B 3/00

(52) U.S. Cl. 82/1.11

(57) ABSTRACT

The invention relates to a method for starting-up a device for peeling a film (4) that is peeled off a substantially round material block (1) that is carried on a shaft (2), by means of a circulating knife arranged below the material block (1) and integrated in a stationary knife bar (3), wherein the material block (1) is adjusted against the knife bar (3) by way of the shaft (2), with the following steps: the material block (1) is lowered until directly above the knife bar (3), the material block (1) is rotationally driven mechanically and adjusted by a predetermined amount relative to the knife bar (3), after a predetermined peeling angle the desired thickness of the film (4) is set by adjustment of the shaft (2), and after at most one revolution of the material block (1) the desired size of the film is achieved.

The invention relates to a method for starting-up a device for peeling a film, which is peeled off a substantially round material block that is carried on a shaft, by means of a circulating knife arranged below the material block and integrated in a stationary knife bar, wherein the material block is adjusted relative to the knife bar by way of the shaft.

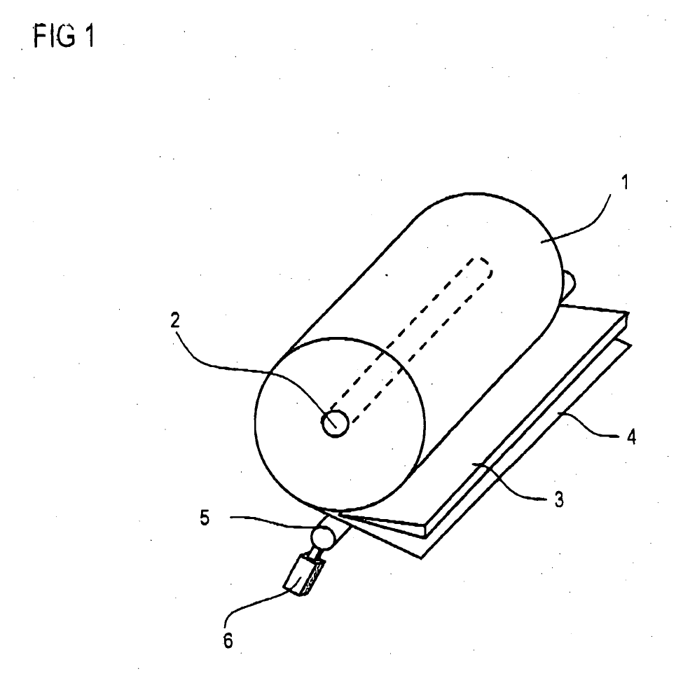

In the production of films from foam material there are usually given approximately round foam material blocks 1 on a shaft 2, which blocks are adjustable relative to a stationary knife bar 3 as illustrated, for example, in FIG. 1. Hitherto, at the beginning of the peeling process the foam material block 1 was rotated by hand and in that case slowly adjusted so that initially protruding foam material regions deviating from the round were cut off. On further adjustment always more is cut off the foam material block 1 until finally the desired thickness of the film 4 is attained. A cut is then carried out transversely through the peeled-off material, this waste is discarded, and the film 4 is given by hand to a winding device (not illustrated) which then looks after the drawing off. When the correct thickness of the film 4 is set, a drive roller 5 is moved by a setting drive 6 against the measuring bar 3. The foam material block 1 now no longer needs to be manually driven. The drive roller 5 drives the film 4.

Methods of that kind are very labor-intensive and time-consuming, since the starting-up process is slowly carried out manually, in addition, a relatively large amount of waste arises until the knife is correctly adjusted and the desired film thickness achieved. The invention proceeds from the task of forming a method of the kind stated in the introduction in such a manner that the method can be carried out rapidly and automatically and produces only a small amount of waste products.

According to the invention the task is solved by the following steps: the material block is lowered until directly above the knife bar, the material block is rotationally driven mechanically and adjusted by a predetermined amount against the knife bar, after a predetermined peeling angle the desired thickness of the film is set by adjustment of the shaft, and after at most one revolution of the material block the desired size of the film is achieved.

It can thereby achieved that the starting-up process can be concluded already after a small rotation, so that it is quicker and less waste arises.

The method can be carried out in simple manner if in step a) a first drive device can be brought into engagement with the material block arid in step 0) after reaching the desired thickness additionally a second drive device can be brought into engagement with the film in the region of the knife.

In advantageous manner the first drive device can be pressure-regulated and the second drive device distance-regulated. It has proved favorable to design the predetermined adjustment amount to be freely selectable.

According to the invention the step a) can be automatically ended after a freely selectable, predeterminable rotational angle or a freely selectable, predetermined number of revolutions of the material block.

In the invention is explained in more detail in the following by way of examples of embodiment illustrated in the drawing, in which:

FIG. 1 shows a known device,

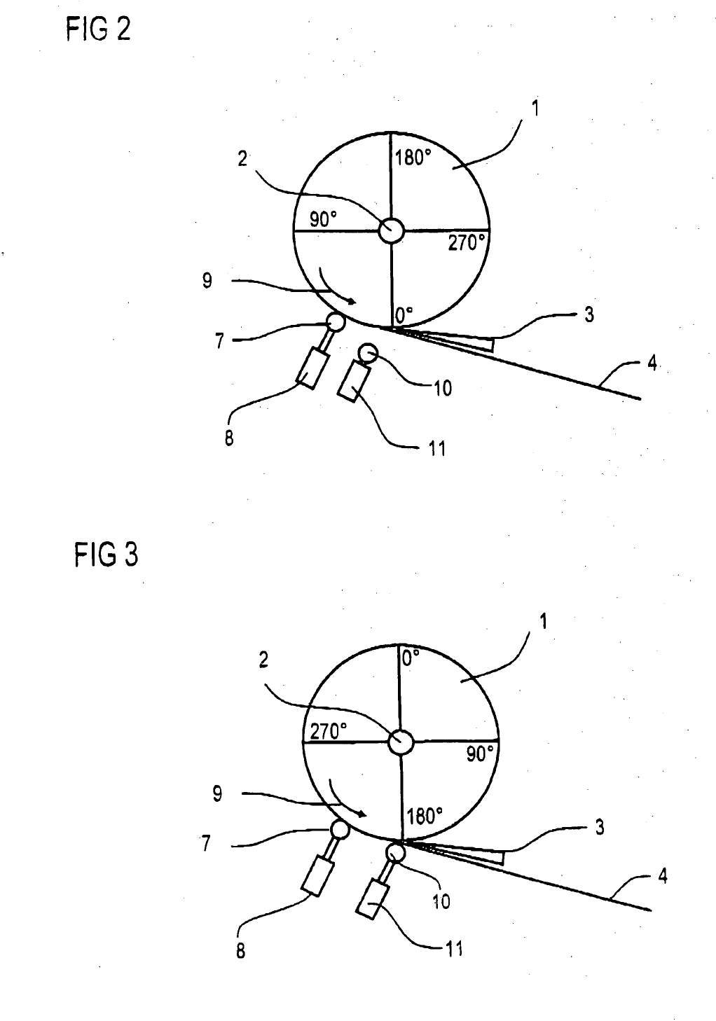

FIG. 2 shows a device during the first step according to the invention and

FIG. 3 shows the device during the second step. according to the invention.

In FIG. 2 the round material block, for example a foam material block, arranged on a shaft 2 is illustrated, which is adjustable against the stationary knife bar 3, in which a circulating knife is integrated, by means of a generally known device (not illustrated). A first drive device with a first drive device 7 constructed as a roller and a first setting drive 8 is pressed by this against the foam material block l and drives it in the direction of the arrow 9. A second drive device 10 with a second drive roller and a second setting drive 11 is disposed in waiting position.

The round foam material block 1, which in the interim was rotated by the first drive device through X plus 360° here by 180° plus 360°, is illustrated in FIG. 3. The second drive device 10 was adjusted by the second setting drive 11 against the film 4 cut off or peeled off the foam material block 1 by means of a knife.

Beforehand, the material peeled off until then, which can have different thicknesses and irregularities, was separated by a cut transversely to the film 4 and removed. The start of the firm 4 can now be gripped and wound up on a winding unit (not illustrated), wherein the preliminary drive of the film 4 can be carried out by the two devices 7 and 10 and in a given can by the driven winding device.

A method according to the invention consists of a two steps, wherein initially the material block 1 consisting of foam material is placed by a sensor means against the knife bar 3. That can be carried out, for example, by a gentle contacting operation, by positioning by way of light barrier scanning, a moment switching-off or the automatic movement up to a specific position, The first drive device 7 is subsequently moved against the material block 1 and drives this in a rotational direction (FIG. 2). in that case the foam material block 1 is adjusted by a defined predeterminable amount against the knife bar 3. The adjustment is carried out pneumatically or hydraulically in known manner. it is thereby achieved that after a freely selectable, predeterminable rotational angle, for example already after 180, the knife is moved, for example, 40 mm into the foam material block 1. The knife is, according to experience thus moved to such a depth into the foam material block 1 that no protruding residues remain any longer.

According to the invention there can now be changeover to the desired thickness of the film 4. After a further revolution of the material block 1 the desired thickness is attained. Thereupon, the cut transversely through the film 4, discarding the waste piece and pressing-on of the second drive device 10 can be carded out. The film 4 is subsequently threaded manually or automatically into a winding device (not illustrated). Through the application of both drive devices 7 and 10 an optimum preliminary drive is achieved. in that case the first drive device 7 is pressure-regulated, whilst the second drive device 10 is distance-regulated or position-regulated.

### Reference Numeral List

1 material block

2 shaft

3 knife bar

4 film

5 drive roller

6 setting drive

7 first drive device

8 first setting drive

9 arrow

10 second drive device

11 second setting drive

1. A method for starting-up a device for peeling a film that is peeled off a substantially round material block that is carried on a shaft, by means of a circulating knife arranged below the material block and integrated in a stationary knife bar, wherein the material block is adjusted against the knife bar by way of the shaft, characterized by the following steps:
a) the material block is lowered until directly above the knife bar, the material block is rotationally driven mechanically and adjusted by a predetermined amount against the knife bar, after a predetermined peeling angle
b) the desired thickness of the film is set by adjustment of the shaft, and after at most one revolution of the material block the desired size of the film is achieved.

2. The method according to claim 1, characterized in that in step a) a first drive device is brought into engagement with the material block and in step b) after attainment of the desired thickness additionally a second drive device is brought into engagement with the film in the region of the knife bar.

3. The method according to claim 2, characterized in that the first drive device is pressure-regulated and the second drive device is position-regulated.

4. The method according to claim 1, characterized in that the predetermined adjustment amount is freely selectable.

5. The method according to claim 1, characterized in that the step a) is automatically ended after a freely selectable, predeterminable peeling angle of the material block.

6. The method according to claim 1, characterized in that the step a) is automatically ended after a freely selectable, predetermined number of revolutions of the material block.
